(19) United States
(12) Patent Application Publication
(10) Pub. No.: US 2003/0224123 A1
(43) Pub. Date: Dec. 4, 2003

(54) Method of determining optimal amount of chemical for pressure treatment of wood and method of pressure treating wood

(76) Inventor: Richard A. Lopez, Dana Point, CA (US)

Correspondence Address: Richard A Lopez, 24683 Santa Clara Avenue, Dana Point, CA, 92629, US

(21) Appl. No.: 10/162,513

(22) Filed: Jun. 3, 2002

(51) Int. Cl. B05D 1/18

(52) U.S. Cl. 427/440; 427/8

(57) ABSTRACT

A method of determining the optimal amount of treatment chemical to use in a pressure-treatment process of a wood product includes providing the dry weight of solids of a treatment chemical solution per volume of wood product required to sufficiently pressure treat a wood product; measuring temperature of the treatment chemical solution (“solution”); measuring specific gravity of the solution; determining percent solids for the solution using a hydrometer table; determining the volume of the solution per volume of wood product required to sufficiently pressure treat wood product based on the specific gravity, the percent solids, weight of water per volume, and the dry weight of solids of a solution per volume of wood product; and determining the volume of the solution required based on volume of wood product to be treated and the volume of the solution per volume of wood product.

### FIELD OF THE INVENTION

The present invention is in the field of wood pressure treating.

### BACKGROUND OF THE INVENTION

In the past, the amount of treatment chemical used to pressure treat a charge of wood has been determined in a relatively subjective manner. A charge of wood (e.g., plywood, lumber) is delivered into a pressure treatment vessel and a door on the vessel is shut. The treatment chemical solution is transferred from a holding tank into the pressure treatment vessel. The vessel is pressurized at a high pressure, causing the treatment chemical solution to treat the wood under pressure. After a period of time, based upon the operator's experience, the operator determines a sufficient amount of treating has occurred and de-pressurizes the vessel. The residual treatment chemical solution may be delivered back into the holding tank and the wood may be removed. In most cases, when treating wood with this process, the wood is over treated with chemical treatment solution. Using too much chemical treatment solution during pressure treatment of wood is inefficient, expensive, and may have a negative impact on the structural integrity of the wood.

### SUMMARY OF THE INVENTION

Accordingly, an aspect of the invention involves determining and delivering an optimal volume of treatment chemical solution for pressure treatment of wood, eliminating the aforementioned problems with the prior art.

Another aspect of the invention involves a method of determining the optimal amount of treatment chemical to use in a pressure-treatment process of a wood product. The method includes providing the dry weight of solids of a treatment chemical solution per volume of wood product required to sufficiently pressure treat a wood product; measuring temperature of the treatment chemical solution; measuring specific gravity of the treatment chemical solution with a hydrometer; determining percent solids for the treatment chemical solution using a hydrometer table; determining the volume of the chemical treatment solution per volume of wood product required to sufficiently pressure treat wood product based on the specific gravity, the percent solids, weight of water per volume, and the dry weight of solids of a treatment chemical solution per volume of wood product; and determining the volume of the chemical treatment solution required based on volume of wood product to be treated and the volume of the chemical treatment solution per volume of wood product to prevent over treatment or under treatment of the wood product.

A further aspect of the invention involves a method of pressure treating a wood product with the optimal volume of treatment chemical. The method includes delivering a charge of wood product into a pressure treatment vessel; delivering a volume of treatment chemical solution to the pressure treatment vessel; pressuring treating the wood product until the volume of treatment chemical solution decreases by a specific predetermined volume; and removing the pressure treated wood product from the pressure treatment vessel.

Further objects and advantages will be apparent to those skilled in the art after a review of the drawings and the detailed description of the preferred embodiments set forth below.

### BRIEF DESCRIPTION OF THE DRAWINGS

FIGS. 1A-1N are hydrometer tables for a preferred embodiment of a fire-retardant treatment chemical solution used in the methods of the present invention.

FIG. 2 is a hydrometer table for a preferred embodiment of a wood preservative treatment chemical solution that may be used in the methods of the present invention.

### DETAILED DESCRIPTION OF PREFERRED EMBODIMENTS

An exemplary method of predicting the optimal amount of treatment chemical to use in a pressure-treatment process, a method of pressure treating wood with an optimal amount of treatment chemical, and a method of verifying the wood is pressure treated with the optimal amount of treatment chemical will now be described. The methods of the present invention will be described in conjunction with the pressure treatment of plywood with a treatment chemical solution. Although the methods are described in conjunction with plywood, the methods described herein apply to lumber, or any other wood or wood-related product that may be pressure treated with a treatment chemical solution.

A preferred embodiment of a fire-retardant treatment chemical solution will first be described before describing the method of predicting the optimal amount of treatment chemical to use in a pressure-treatment process, a method of pressure treating wood with an optimal amount of treatment chemical, and method of verifying the wood is pressure treated with the optimal amount of treatment chemical. The treatment chemical solution is preferably a fire-retardant coating solution; however, other treatment chemical solutions may be used. The treatment chemical solution is a stable, non-corrosive preservative composition that imparts fire, insect, and fungus resistance qualities to the plywood. The treatment chemical solution is an aqueous solution of a boron-source composition selected from the group consisting of boric acid and the water-soluble salts thereof, a melamine binder resin, and a urea casein activator resin. The amount of the boron source composition, melamine binder resin, and urea casein activator resin are adjusted so that the resultant preservative composition has a weight ration of boron source to melamine ranging from 1.30:1 to 9.6:1, preferably about 8:1, and a weight ration of urea casein activator resin to melamine binder resin ranging from 1:20 to 1:4, preferably about 5.5:1.

The boron-source composition can be boric acid or the water-soluble salts of boric acid, including sodium tetraborate decahydrate, sodium tetraborate pentahydrate, sodium octaborate tetrahydrate, sodium metaborates, sodium perborate hydrates, potassium tetraborate, sodium pentaborate, ammonium pentaborate hydrate, and hydrasodium tetraborate, potassium metaborate, any alkali metal borate salt, or combinations of these compounds. Preferably, the boron source composition is disodium octaborate tetrahydrate, which is commercially available from IMC Chemical, Overland Park, Kans. or U.S. Borax, Inc., Valencia, Calif. The boron-source compound is a primary fire retardant, as well as an insecticidal and fungicidal agent.

The melamine binder resin can be any amino resin made from melamine (2,4,6-triamino symtriazine) and formaldehyde, typically used for marine graded plywood, or as a nitrogen source in binders used to make pipe insulation. The melamine binder resin is characterized by a viscosity (@ 78° F.) ranging from 600-1000, a pH ranging from 8.6-9.7, a free formaldehyde concentration less than 0.5% by weight, a specific gravity of about 1.2, and a degree of polymerization of about 2.1. The melamine-binder resin acts as a nitrogen-liberating compound, releasing nitrogen in the presence of a flame. The melamine binder resin includes modified melamine-formaldehyde resins such as GP® 482T23 Thermal Insulation Binder Resin or GP® 476T19 Melamine Insulation Resin, both commercially available from Georgia-Pacific Resins, Inc, Dekatur, Ga., or MB 46-50 Liquid Melamine Adhesive commercially available from National Casein or Cytek, located in Santa Ana, Calif., and Jersey City, N.J., respectively. Preferably, the melamine binder resin is a liquid.

The urea casein activator resin can be any liquid urea formaldehyde resin typically used for marine or N graded plywood. The casein resin activator is characterized by a viscosity (@ 78° F.) of about 550 cp, solids percentage of 63%-67%, a pH of about 7.5, a specific gravity ranging from 1.20-1.38, and a formaldehyde concentration less than 1.5%. The urea casein activator resin is also nitrogen-liberating compound, which releases nitrogen in the presence of a flame. Preferably, the urea casein activator resin is #750 Urea Resin Adhesive or GP® 1967, commercially available from National Casein, Santa Ana, Calif. and Georgia Pacific Resins, Decatur, Ga., respectively.

After application to the treated plywood, the urea casein activator resin initiates a polymerization reaction involving the melamine binder resin. The resulting melamine polymer creates a substantially impervious barrier to atmospheric moisture and also binds or encapsulates the wood preservative composition to the treated plywood to prevent leaching of the boron source composition from the treated plywood through solubalization by atmospheric moisture. The melamine polymer acts as a nitrogen-liberating compound, which releases nitrogen in the presence of a flame.

The treatment chemical solution may be prepared by mixing one or more of the boron source compositions, the melamine binder resin, and the urea casein activator resin in an aqueous solution. The boron source compositions may first be dissolved in water and then mixed with the melamine binder resin and the urea casein activator resin, in that order. The melamine binder resin and urea casein activator resin may be each individually mixed in water before addition to the other ingredients of the preservative composition. This allows the proper buffering effect to occur. Generally, the urea casein activator resin is added last. The preservative composition may also be formed by first combining the melamine binder resin and the urea casein activator resin with water to form an aqueous solution. The aqueous solution of the melamine binder urea casein resin activator may then be added to an aqueous solution of the boron-source composition. Alternatively, the preservative composition may be formed in a step process within the wood products themselves by first applying the boron-source composition and then applying an aqueous solution comprising the melamine binder resin and the urea casein activator resin.

Further information on the preferred treatment chemical solution used is described in U.S. application Ser. No. 09/615,259, entitled “FIRE RETARDANT COMPOSITIONS AND METHODS FOR PRESERVING WOOD PRODUCTS”, filed Jul. 13, 2002, which is incorporated by reference herein as though set forth in full.

A method of predicting the optimal amount of treatment chemical to use in a pressure-treatment process will now be described. In accordance with Specification Test Title UL-723, ASTM E-84, NFPA 255, Test for Surface Burning Characteristics of Building Materials, Underwriters Laboratories, Inc. of Northbrook, Ill., the inventor has determined that substantially 1.50 lbs. Solids/Cu. Ft. (Dry) of the fire-retardant treatment chemical solution per cubic foot of plywood is optimal for fire-retardant pressure treatment of plywood. In regard to lumber, the inventor has also determined that substantially 1.05 lbs. Solids/Cu. Ft. (Dry) of the treatment chemical solution per cubic foot of wood is ideal for fire-retardant pressure treatment of lumber. For a wood preservative borate solution, the inventor has determined that substantially 0.17 lbs. Solids/Cu. Ft. (Dry) of the borate solution per cubic foot of wood is ideal for wood preserving in most geographical locations and substantially 0.28 lbs. Solids/Cu. Ft. (Dry) of the borate solution per cubic foot of wood is ideal for wood preserving in geographical locations with more termite problems such as Asia and Hawaii.

The method for determining the lbs. Solids/Cu. Ft. (Dry) amounts will now be generally described for lumber. Sixty (60) samples (2 in.×6 in.×8 ft.) of lumber with a moisture content of 19% or less are weighed before and after pressure treatment with the treatment chemical solution to determine the lbs. Solids/Cu. Ft. (Dry) amounts for each lumber sample. The median lbs. Solids/Cu. Ft. (Dry) is determined from the sixty samples with the highest twelve lbs. Solids/Cu. Ft. (Dry) samples and the lowest twelve lbs. Solids/Cu. Ft. (Dry) samples dropped, leaving thirty-six samples. The thirty-six samples are arranged into three sets of twelve samples. Each set of twelve samples is separated into three parcels of four samples. The three sets are placed in a furnace or oven for fire testing. If all three sets pass the fire testing, than the median (e.g., 1.05) is established as a sufficient fire-retardant level in lbs. Solids/Cu. Ft. (Dry) for the particular treatment chemical solution and type of wood. The same process was performed to establish 1.50 lbs. Solids/Cu. Ft. (Dry) as the fire-retardant level for the treatment chemical solution for plywood.

Next, the temperature of the treatment chemical solution is obtained from a temperature gauge on a holding tank holding the treatment chemical solution.

Then, the specific gravity of the treatment chemical solution is determined using a hydrometer.

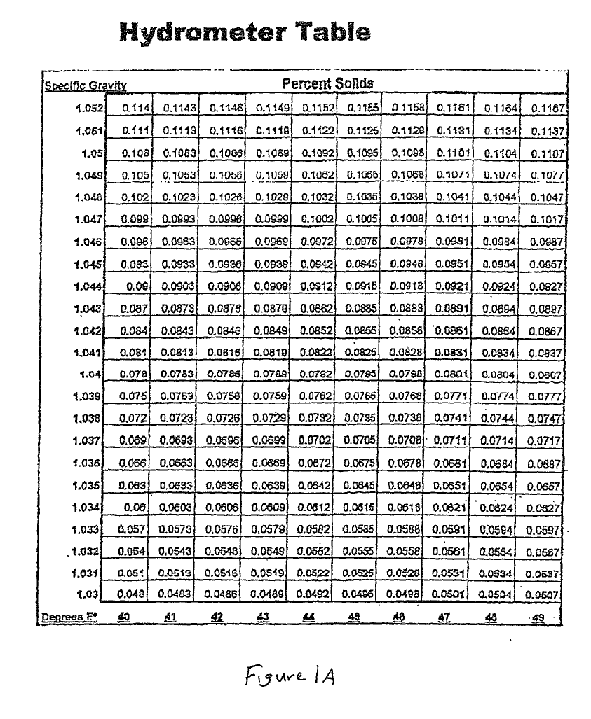

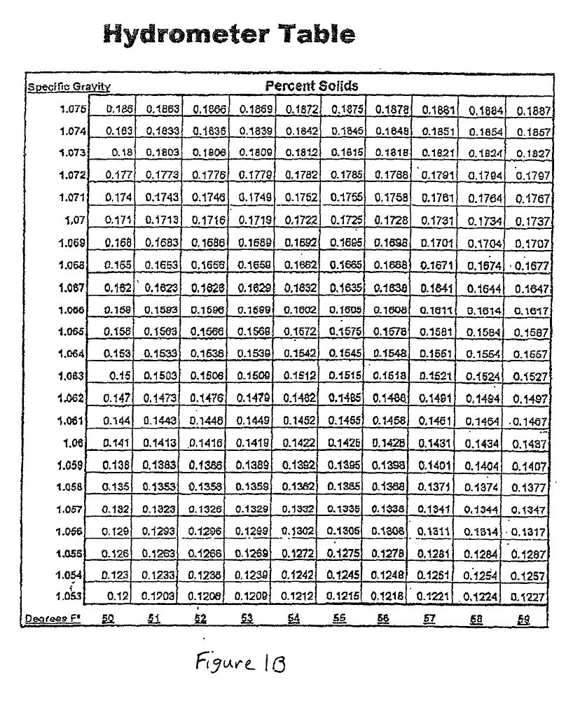

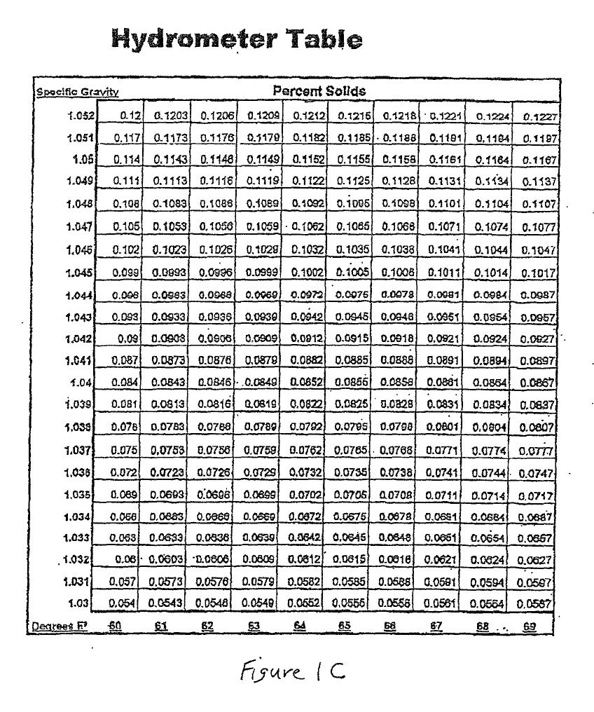

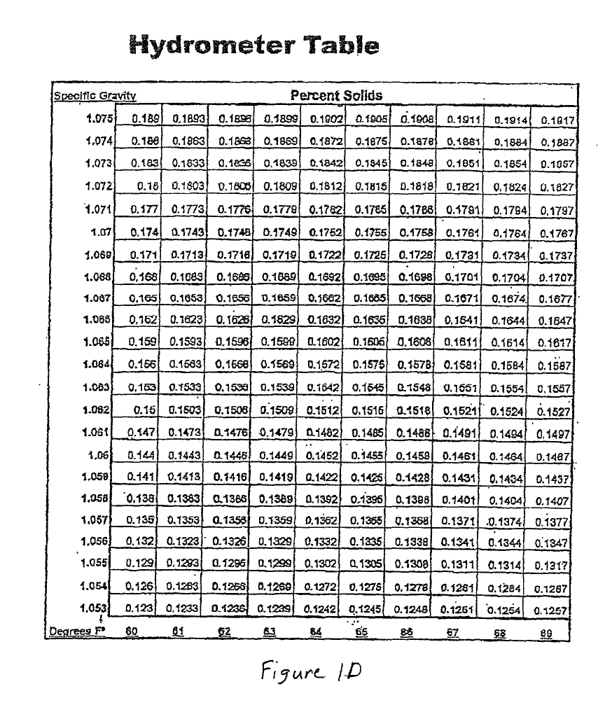

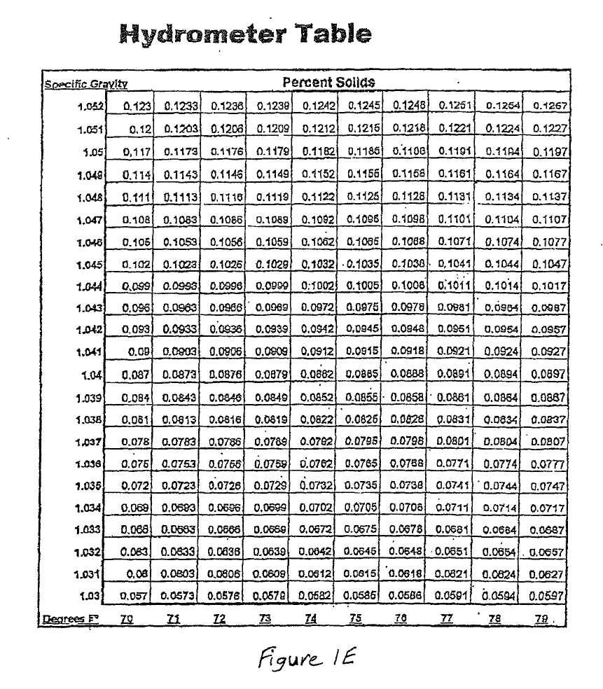

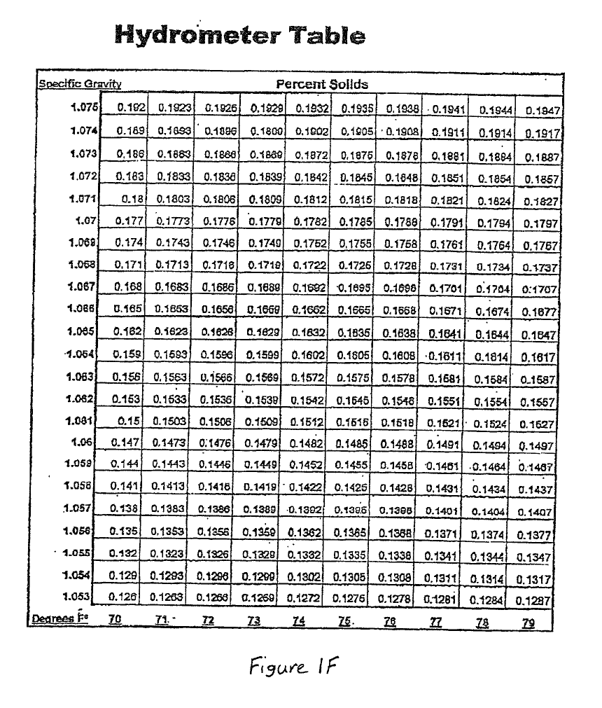

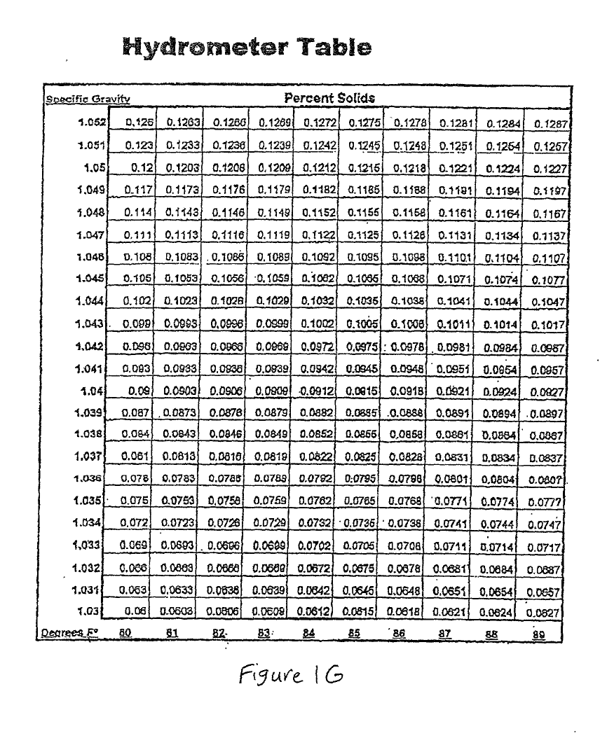

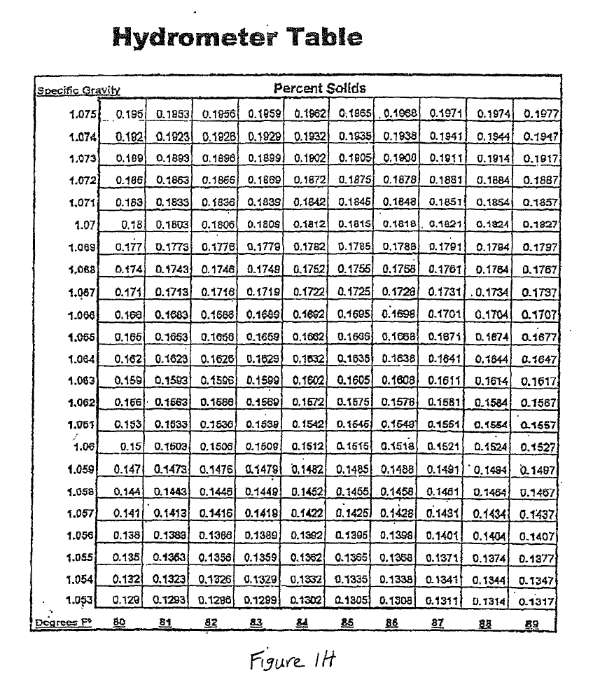

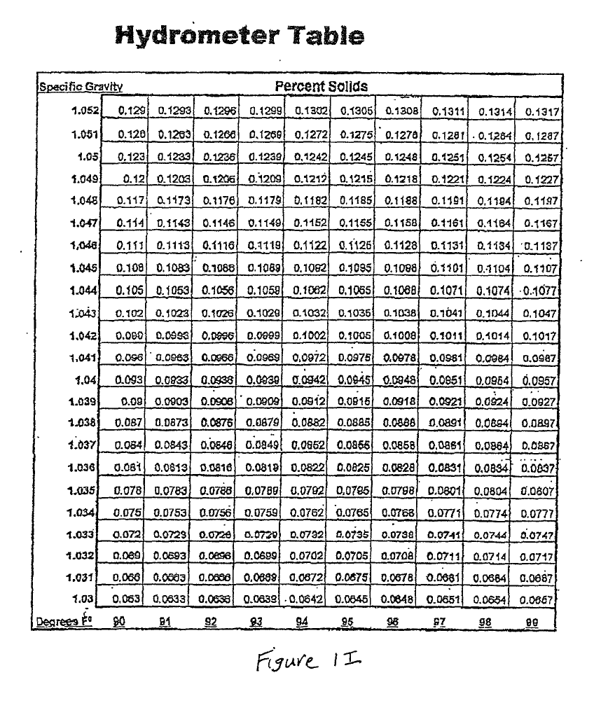

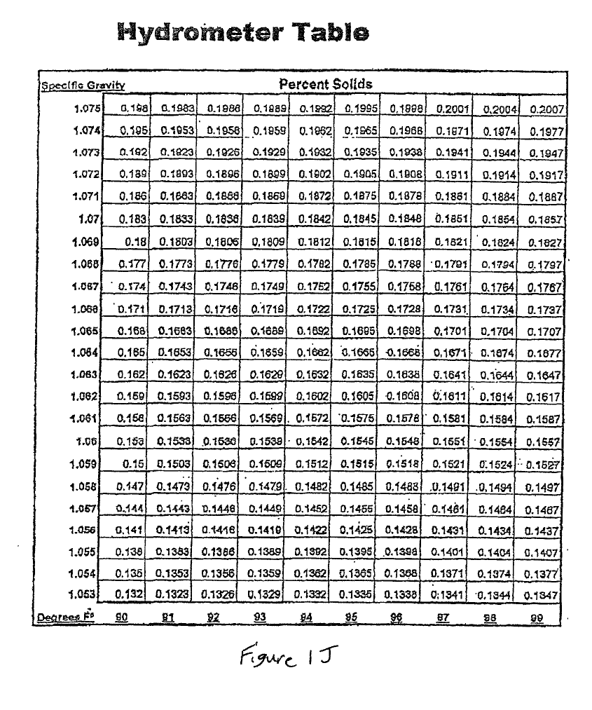

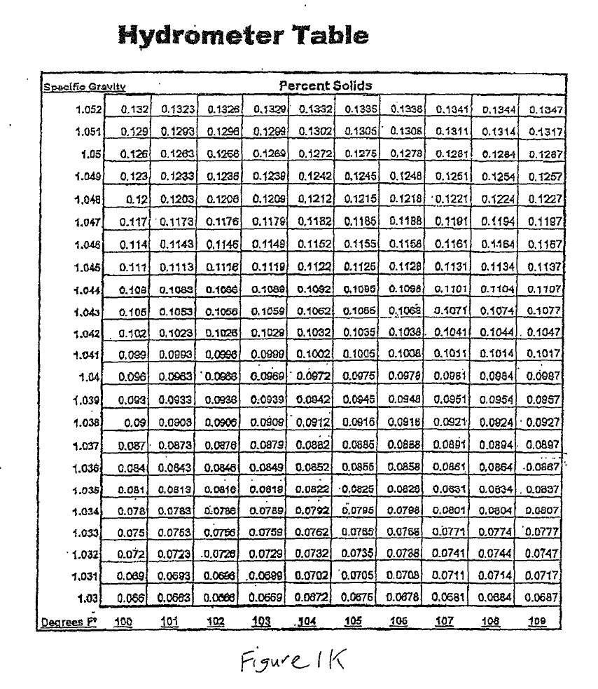

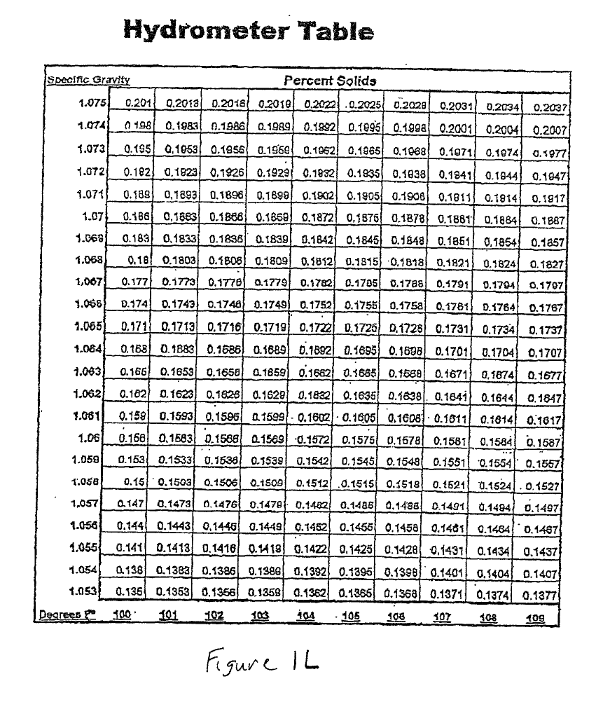

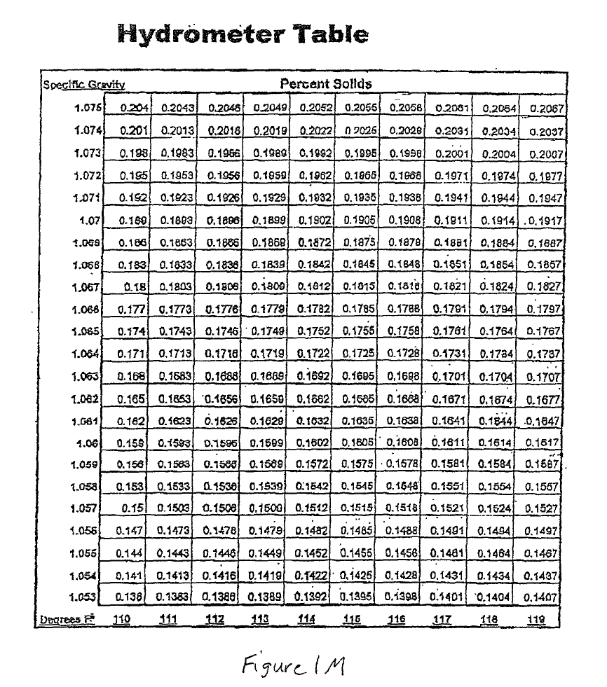

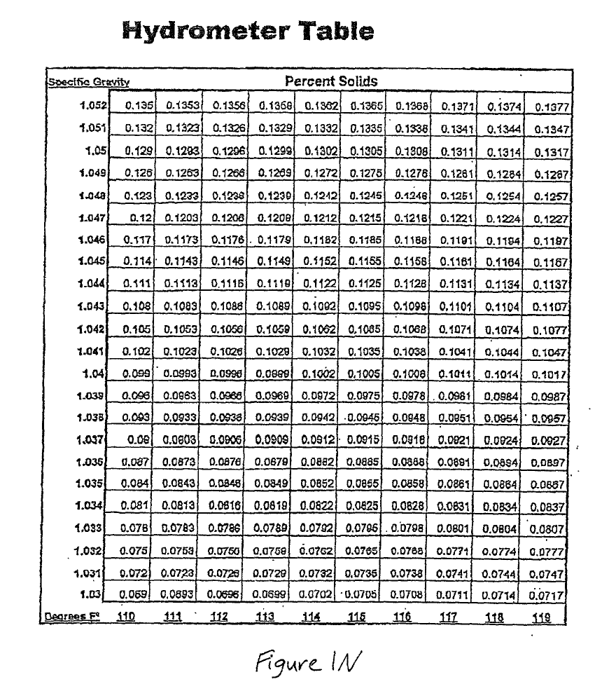

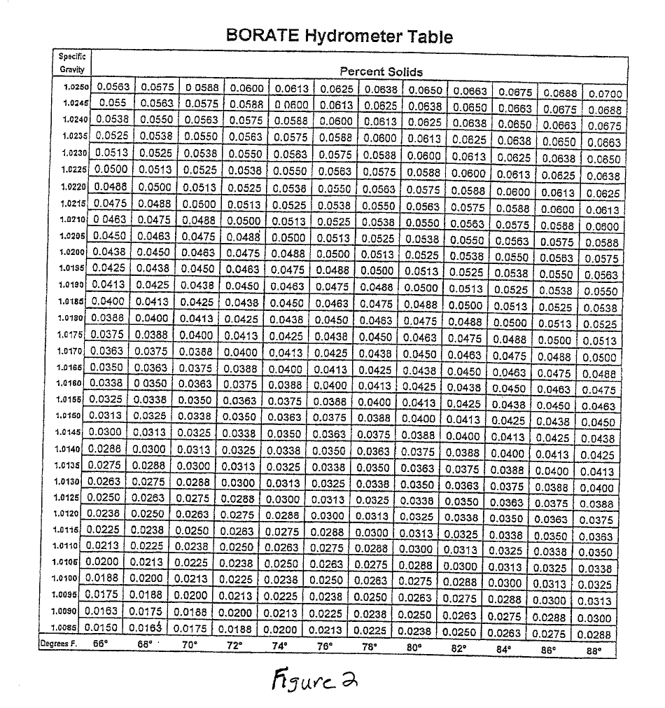

FIGS. 1A-1N illustrate exemplary hydrometer tables for the preferred fire-retardant treatment chemical solution described above. Similarly, FIG. 2 illustrates an exemplary hydrometer table for a preferred wood-preservative Borate solution. From the hydrometer tables shown in FIG. 1, the percent solids are obtained based on the measured temperature and specific gravity.

To determine Gallons/Cu. Ft. retained, the following Equation 1 may be used:

A×B×C×D=E, Equation 1

Where A=Gallons/Cu. Ft. retained, B=Weight of water/gallon=8.33 lbs/Gallon, C=Specific Gravity, D=% Solids, E=lbs. Solids/Cu Ft. (Dry)

Equation 1 can be rearranged to the following Equation 2:

A=E/(B×C×D) Equation 2

Variable A from Equation 2 may be solved from the hydrometer reading (C), the % Solids (D) determined from the hydrometer tables, and the known values for B (8.33 lbs/Gallon), and E (1.50 lbs. Solids/Cu Ft. (Dry)).

Once Gallons/Cu. Ft. retained (A) is determined, the optimal volume of treatment chemical solution required (F) for treating the plywood is determined from the following equation 3:

F=A×G, where G=the Cu. Ft. of plywood (length×width×height) in the lumber charge. Equation 3

A method of pressure treating wood with the optimal volume (F) of treatment chemical calculated above will now be described.

The charge of plywood to be treated is put on a tram and delivered into the pressure treatment cylinder or vessel. Next, the door on the pressure treatment cylinder is shut.

A totalizer associated with the pressure treatment cylinder maintains and displays a running total of the volume of treatment chemical solution that flows therethrough. This total amount indicated by the totalizer is noted before filling the pressure treatment cylinder with treatment chemical solution.

Next, approximately 2,500-3,000 gallons of treatment chemical solution from a holding tank is delivered to the pressure treatment cylinder. One or more pumps may be used to transfer the treatment chemical solution from the holding tank to the pressure treatment cylinder. Alternatively, a vacuum may be imparted to the pressure treatment cylinder, causing the treatment chemical solution to flow from the holding tank to the pressure treatment cylinder. Treatment chemical solution is delivered to the pressure treatment cylinder until a volume level meter on the pressure treatment cylinder indicates 95-100 or 95-100% full. The volume level meter may indicate the percent full of the pressure treatment cylinder, in increments or ticks of one, i.e., 1%, 2%, 3%, . . . 99%, 100%.

The total amount indicated by the totalizer after filling the pressure treatment cylinder with treatment chemical solution is noted again, and the difference between the totalizer amount after filling the pressure treatment cylinder and totalizer amount before filling the pressure treatment cylinder is determined. This difference is the total volume of treatment chemical solution in the pressure treatment cylinder. For example, if the totalizer indicated 6,000 before filling the pressure treatment cylinder and 9,000 after filling the pressure treatment cylinder, the total volume of treatment chemical solution in the pressure treatment cylinder is 3,000 gallons (G).

The volume of treatment chemical solution represented by each tick or increment of the volume level meter (H) is calculated by dividing the total volume of treatment chemical solution in the pressure treatment cylinder (G) by the total number of ticks or increments of the volume level meter (I), i.e., the percent full indicated by the volume level meter (e.g., 95%, 96%, 97%, 98%, 99%, or 100%). For example, if the total volume of treatment chemical solution in the pressure treatment cylinder (G) is 3,000 gallons and the volume level meter reads 100 or 100% (I), the volume of treatment chemical solution represented by each tick of the volume level meter (H)=G/l=3,000/100=30 gallons/tick.

The number of ticks on the volume level meter representative of the optimal volume of treatment chemical solution (F) required for treating the plywood is determined by dividing the volume of treatment chemical solution (F) required for treating the plywood by the volume of treatment chemical solution represented by each tick (H). For example, if 450 gallons (F) is determined to be the optimal volume of treatment chemical solution required for treating the plywood and the volume of treatment chemical solution represented by each tick of the volume level meter (H) is 30 gallons/tick, then 15 ticks on the volume level meter represents 450 gallons of treatment chemical solution.

The pressure in the pressure treatment cylinder is increased to 100 psi and the lumber charge is pressure treated with the treatment chemical solution until the volume of the treatment chemical solution falls to a predetermined level. Using the example above, if the volume level meter starts at 100 or 100% at the beginning of the process, when the volume level meter ticks down 15 ticks to 85 or 85%, the operator knows that the plywood charge has been pressure treated with the optimal 450 gallons (15 ticks×30 gallons/tick) of treatment chemical solution.

Once the volume level of treatment chemical solution in the pressure cylinder is reduced an amount equal to the volume of treatment chemical solution required for treatment of the plywood charge, the pressure treatment process is stopped.

The door on the pressure treatment cylinder is opened and the lumber charge may be transported on the tram out of the pressure treatment cylinder.

After completing the treating process, the one or more pumps that delivered the treatment chemical solution from the holding tank to the pressure treatment cylinder may be reversed so that the remaining treatment chemical solution in the pressure treatment cylinder is transferred back through filters, into the holding tank.

A vacuum may be applied to the pressure treatment cylinder to remove excess treatment chemical solution on the surface of the plywood to facilitate later drying of the plywood.

Alternatively, the charge of treated lumber may then be transported to horizontal drip tanks where the lumber is washed with treatment chemical solution and then allowed to drip.

The treated lumber may then be air dried. The lumber may be tickered to speed the drying process and to prevent warping during the drying period. The lumber is dried until the moisture content is 19% or less.

A method of verifying the wood is pressure treated with the optimal amount of treatment chemical will now be described.

The plywood charge may include one or more wooden tube sticks that undergo the pressure treatment process with the lumber charge. The tube sticks may be used to verify the wood is pressure treated with the optimal amount of treatment chemical.

For example, the tube sticks may be weighed before and after the pressure treatment process. The difference in weight divided by the volume of the tube stick yields the lbs. Solids/Cu. Ft. (Dry) of the treatment chemical solution per cubic foot of plywood. This value is compared to the aforementioned standard of 1.05 lbs. Solids/Cu. Ft. (Dry) in accordance with Specification Test Title UL-723, ASTM E-84, NFPA 255, Test for Surface Burning Characteristics of Building Materials, Underwriters Laboratories, Inc.

The tube sticks may also be dried by putting them in an oven for 24 hours and 212 degrees F. The tube sticks are weighed before and after drying. The difference in the weight before and after yields the moisture content, which may be compared to known standards for determining if the moisture content of the plywood charge is acceptable.

The tube sticks may also undergo a fire tube test in which the tube sticks undergo a 4 minute burn at 345-356 degrees F. within a sheet metal tube using a Bunsen burner. The tube sticks are weighed before and after the burning process. The difference in the weight before and after divided by the total weight before yields weight loss, which may be compared to standards for determining if the fire retardant properties of the plywood charge are acceptable.

It will be readily apparent to those skilled in the art that still further changes and modifications in the actual concepts described herein can readily be made without departing from the spirit and scope of the invention as defined by the following claims.

What is claimed is:

1. A method of determining the optimal amount of treatment chemical to use in a pressure-treatment process of a wood product, comprising the steps of:
providing the dry weight of solids of a treatment chemical solution per volume of wood product required to sufficiently pressure treat a wood product;
measuring temperature of the treatment chemical solution;
measuring specific gravity of the treatment chemical solution with a hydrometer;
determining percent solids for the treatment chemical solution using a hydrometer table;
determining the volume of the chemical treatment solution per volume of wood product required to sufficiently pressure treat wood product based on the specific gravity, the percent solids, weight of water per volume, and the dry weight of solids of a treatment chemical solution per volume of wood product;
determining the volume of the chemical treatment solution required based on volume of wood product to be treated and the volume of the chemical treatment solution per volume of wood product to prevent over treatment or under treatment of the wood product.

2. The method of claim 1, wherein the dry weight of solids of a treatment chemical solution per volume of wood product is lbs. Solids/Cu Ft. (Dry).

3. The method of claim 1, wherein the treatment chemical solution is a fire-retardant solution including an aqueous solution of a boron-source composition selected from the group consisting of boric acid and the water-soluble salts thereof, a melamine binder resin, and an urea casein activator resin, the wood product is plywood, and the lbs. Solids/Cu Ft. (Dry) required for fire retardant treatment of lumber is substantially 1.05 lbs. Solids/Cu Ft. (Dry).

4. The method of claim 2, wherein the treatment chemical solution is a fire-retardant solution including an aqueous solution of a boron-source composition selected from the group consisting of boric acid and the water-soluble salts thereof, a melamine binder resin, and an urea casein activator resin, the wood product is plywood, and the lbs. Solids/Cu Ft. (Dry) required for fire retardant treatment of plywood is substantially 1.50 lbs. Solids/Cu Ft. (Dry).

5. The method of claim 2, wherein the treatment chemical solution is a borate solution, and the lbs. Solids/Cu Ft. (Dry) required for wood preservation of the wood product is substantially 0.17 lbs. Solids/Cu Ft. (Dry).

6. The method of claim 2, wherein the treatment chemical solution is a borate solution, and the lbs. Solids/Cu Ft. (Dry) required for wood preservation of the wood product is substantially 0.28 lbs. Solids/Cu Ft. (Dry).

7. The method of claim 1, wherein the volume of the chemical treatment solution per volume of wood product required to sufficiently pressure treat wood product is determined using the following formula:
(Gallons/Cu. Ft. retained)=(lbs. Solids/Cu Ft. (Dry))/(8.33×(Specific Gravity)×(% Solids)).

8. The method of claim 7, wherein the volume of the chemical treatment solution required for treatment is determined by multiplying (Gallons/Cu. Ft. retained) by the volume of wood product to be treated.

9. A method of pressure treating a wood product with the optimal volume of treatment chemical, comprising the steps of:
delivering a charge of wood product into a pressure treatment vessel;
delivering a volume of treatment chemical solution to the pressure treatment vessel;
pressuring treating the wood product until the volume of treatment chemical solution decreases by a specific predetermined volume of treatment chemical solution;
removing the pressure treated wood product from the pressure treatment vessel.

10. The method of claim 9, wherein the specific predetermined volume of treatment chemical solution is determined by providing the dry weight of solids of a treatment chemical solution per volume of wood product required to sufficiently pressure treat a wood product; measuring temperature of the treatment chemical solution; measuring specific gravity of the treatment chemical solution with a hydrometer; determining percent solids for the treatment chemical solution using a hydrometer table; determining the volume of the chemical treatment solution per volume of wood product required to sufficiently pressure treat wood product based on the specific gravity, the percent solids, weight of water per volume, and the dry weight of solids of a treatment chemical solution per volume of wood product; and determining the specific predetermined amount of treatment chemical solution required based on volume of wood product to be treated and the volume of the chemical treatment solution per volume of wood product.

11. The method of claim 9, wherein the volume of treatment chemical solution delivered to the pressure treatment vessel is measured using a totalizer.

12. The method of claim 11, wherein the volume of treatment chemical solution is approximately 2,500-3,000 gallons of treatment chemical solution.

13. The method of claim 11, wherein the pressure treatment vessel is filled with treatment chemical solution until it is substantially 95-100% full.

14. The method of claim 9, wherein the treatment chemical solution is a fire-retardant solution including an aqueous solution of a boron-source composition selected from the group consisting of boric acid and the water-soluble salts thereof, a melamine binder resin, and an urea casein activator resin.

15. The method of claim 9, wherein the treatment chemical solution is a borate wood preservative solution.

16. The method of claim 9, wherein the wood product is member from the group consisting of plywood and lumber.

17. The method of claim 9, wherein pressuring treating the wood product until the volume of treatment chemical solution decreases by a specific predetermined volume includes monitoring a volume level meter for a decrease in the treatment chemical solution by the specific predetermined volume and stopping pressure treatment when the gauge shows a decrease in treatment solution volume by the specific predetermined amount.

18. The method of claim 9, wherein the wood product is pressure treated at substantially 100 psi.

19. The method of claim 9, further including applying a vacuum to the pressure treatment vessel to remove excess treatment chemical solution from surfaces of the wood product.

20. The method of claim 9, further including verifying the wood product is pressure treated with the optimal amount of treatment chemical solution by at least one of performing a burn test on a wood sample, performing a drying test on a wood sample, and determining on a wood sample a dry weight of solids of the treatment chemical solution per volume of wood product.
